(19) United States
(12) Patent Application Publication
(10) Pub. No.: US 2020/0060946 A1
(43) Pub. Date: Feb. 27, 2020

(54) EMESIS CONTAINER

(71) Applicant: Jamie Riese, Santa Monica, CA (US)

(72) Inventor: Jamie Riese, Santa Monica, CA (US)

(21) Appl. No.: 16/109,522

(22) Filed: Aug. 22, 2018

(51) Int. Cl. A61J 19/02

(52) U.S. Cl. CPC A61J 19/02

(57) ABSTRACT

An apparatus for containing vomit comprised of a bottom portion, a side, a backflow containment portion and a rim. The bottom portion, side and backflow containment portion are combined to form a container which will not allow vomit to escape once it has entered the container. The rim is attached to the backflow containment portion opposite the container so that when the user vomits through the rim, the vomit passes through the backflow containment portion and is contained within the container.

### BACKGROUND OF THE INVENTION

### (1) Field of Invention

The present invention relates to medical devices which contain bodily fluids, more particularly to those which contain vomit.

### (2) Description of Related Art

Emesis, or the act of vomiting, occurs frequently in humans. The most common causes are viral infections, drinking, food poisoning, morning sickness, reactions to medications, motion sickness, and gastritis. However, some less common causes of vomiting are typically seen in hospitals, such as: concussion, diabetes, appendicitis, gastrointestinal cancer, intestinal obstruction, kidney disease, and diseases of the internal organs. The traditional methods of containing vomit in a home or hospital setting include dishes, trays, bags, or moving the patient to a sink or basin.

Vomiting is a rapid evacuation of stomach contents. Vomit volume varies by person, but 600-700 ml is typical. Additionally, vomiting is somewhat predictable based on the situation, but unpredictable as to the exact time an episode will occur. In other words, an individual based on their situation might expect to vomit at some time in the near future, but would not be able to predict the actual time of vomiting until moments before an episode occurs. This combination of rapid evacuation of a substantial volume of vomit, coupled with unpredictable timing, makes the choice of container difficult. If the container is too cumbersome, like a basin or sink, then it becomes impossible to transport and carry and the vomiting individual must be transported to the container. If the container is configured in a way that makes it difficult to use quickly, like a folded vomit bag, then it might not be ready in time to serve its function. If the container is poorly shaped, like the standard kidney-shaped vomit tray used by hospitals, then it may be overwhelmed by the flow rate of the vomit.

Vomit contains many dangerous and potentially infectious substances in addition to being foul smelling. Some of the substances include bile, food, blood, and gastric secretions. Handling vomit, like all bodily fluids, is dangerous and special precautions must be taken when doing so. Thus, an essential element in a vomit containment apparatus is the ability to contain the vomit and to minimize contact with it during the collection process and the disposal process. This requirement is further complicated when the vomiting occurs in unpredictable and difficult-to-control environments such as the sidelines of a sporting event, or the back of a moving ambulance. Environments such as these require vomit containers that are both portable, easy to use, and sanitary. The standard container solutions fall short in these areas. Many open topped containers, like dishes or trays, carry a substantial risk of exposing humans to vomit during the capture process and disposal process. Bags might allow for disposal, but can be difficult to use quickly in a way that will contain all the expelled fluids, particularly in the moving ambulance scenario.

In addition to practical considerations of container configuration and container sanitation are humane considerations. For many, vomiting is both traumatic, disgusting, and unpleasant. It is a frightening experience, particularly for small children. It can be an unpleasant reminder of the larger medical condition of which it is a symptom. Increasing patient comfort generally improves outcomes. Thus, by decreasing the discomfort of vomiting as much as possible, patient outcomes may improve.

The present invention improves upon the typical solution by providing a portable apparatus for containing vomit that both increases user comfort, decreases spillage during the collection process and the disposal process, and decreases contact with dangerous bodily fluids.

Thus, given the general concerns for all vomit containment systems of collection effectiveness, safety and user comfort, a continuing need exists for a vomit collection apparatus that is improves upon the typical solutions.

### SUMMARY OF INVENTION

The present invention relates to medical devices which contain vomit. The emesis container comprises a bottom portion a side proximate the bottom portion a backflow prevention portion proximate the side and a rim proximate the backflow prevention portion and opposite the bottom portion, such that the bottom portion, side and backflow prevention portion form a container capable of holding vomit.

In another aspect, the device contains at least one hinged door arranged in a fashion that when closed, the door substantially confines the vomit within the container.

Furthermore, the device has an elastic portion affixed to the door and the walls, such that the door will remain closed unless vomit introduced via the rim forces the door open and following passage of the vomit will cause the door to close.

In yet another aspect, the backflow prevention portion comprises at least one elastomer door arranged in a fashion that when closed substantially confine the vomit within the container, wherein the elastomer door will remain closed unless vomit introduced via the rim forces the elastomer door open and following passage of the vomit will return to the closed position.

In still another aspect, the backflow prevention portion is incorporated into the walls and the walls are formed in such a manner that restricts the movement of vomit within the container.

In another aspect, the backflow prevention portion comprises at least one baffle which restricts the movement of vomit within the container.

In yet another aspect, the apparatus further comprises a removable disposable liner which substantially conforms to the interior of the container.

In still another aspect, the backflow prevention portion is incorporated into the removable disposable liner.

In another aspect, the rim is shaped in a manner that allows it to conform to a user's mouth.

In yet another aspect, the rim is made of a deformable material to increase conformance with the user's mouth.

In still another aspect, the apparatus further incorporates at least one handle proximate the container.

In another aspect, the apparatus further incorporates antimicrobial materials.

In yet another aspect, the apparatus further incorporates an absorbent material.

In still another aspect, the apparatus further incorporates a chemical deodorant.

In another aspect, the apparatus further incorporates a removable cap proximate the rim.

In yet another aspect, the apparatus further incorporates a leash which is proximate to the container and proximate to the removable cap.

In still another aspect, the backflow prevention portion and rim is separable from the side such that when the backflow prevention portion is separated from the side the vomit may be removed from the container.

Finally, as can be appreciated by one skilled in the art, the present invention also comprises a method for forming the interactive package described herein.

### BRIEF DESCRIPTION OF THE DRAWINGS

The objects, features and advantages of the present invention will be apparent from the following detailed descriptions of the various aspects of the invention in conjunction with reference to the following drawings, where:

FIG. 1A is a perspective view illustration of an apparatus for containing vomit according to the present invention;

FIG. 1B is a perspective view illustration of an apparatus for containing vomit according to the present invention;

FIG. 2 is a front-view illustration of an apparatus for containing vomit according to the present invention;

FIG. 3 is a front-view illustration of an apparatus for containing vomit according to the present invention;

FIG. 4 is a perspective view illustration of an apparatus for containing vomit according to the present invention;

FIG. 5 is a front-view illustration of an apparatus for containing vomit according to the present invention;

FIG. 6 is a front-view illustration of an apparatus for containing vomit according to the present invention;

FIG. 7 is a front-view and top-view illustration of an apparatus for containing vomit according to the present invention;

FIG. 8 is a perspective view illustration of an apparatus for containing vomit according to the present invention;

FIG. 9 is a perspective view illustration of an apparatus for containing vomit according to the present invention;

FIG. 10 is a front-view illustration of an apparatus for containing vomit according to the present invention; and

FIG. 11 is a perspective view illustration of an apparatus for containing vomit according to the present invention.

### DETAILED DESCRIPTION

The present invention relates to a vomit containment apparatus. The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

Before describing the invention in detail, an introduction is provided to give the reader a general understanding of the present invention. Next, a description of various aspects of the present invention is provided to give an understanding of the specific details.

(1) Introduction

The present invention relates to an apparatus for containing vomit. The apparatus generally comprises a bottom portion, a side, a backflow prevention portion, and a rim. The bottom portion, side, and backflow prevention portion collectively form a container which is capable of holding vomit. The rim is proximate the backflow prevention portion but opposite to container.

(2) The Interactive Package

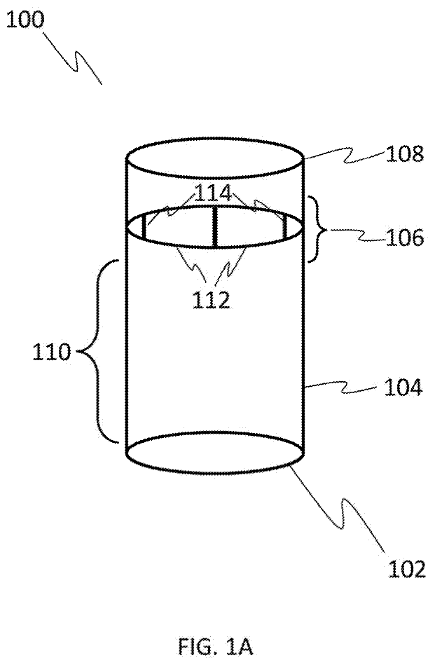

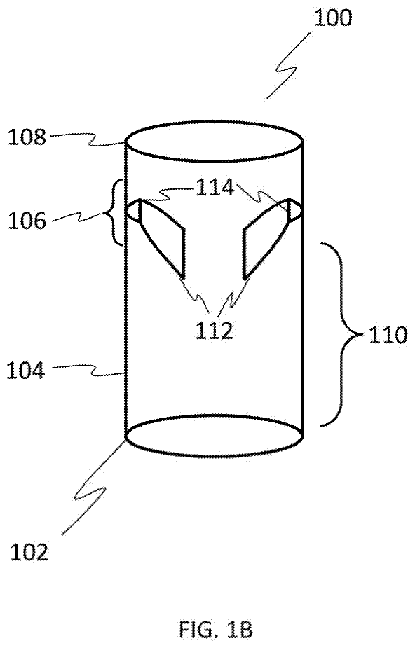

As shown in FIG. 1A, the present invention is an apparatus for containing vomit 100. The apparatus is comprised of a bottom portion 102, a side 104, a backflow prevention portion 106 and a rim 108. The bottom portion 102 and side 104 are connected to the backflow prevention portion 106 in such a manner that they create a container 110 capable of holding and containing vomit. The rim 108 is attached with the backflow prevention portion 106 in a manner that allows the user to vomit through the rim 108. As the user does so, the vomit passes through the backflow prevention portion 106 and into the container 110. Once inside the container 110, the vomit is prevented from escaping by the backflow prevention portion 106. This allows the user to vomit in a more contained and sanitary fashion than the prevailing methods.

The bottom portion 102 and side 104 can be formed of any suitable, corrosion resistant, non-porous material, non-limiting examples of which include, plastic, metal, ceramic, and composite. In FIG. 1A (and as depicted in FIGS. 1B, 2-6 and 10) the material of the bottom portion 102 and the side 104 is shown as transparent for the sake of illustration, but need not be in practice. The backflow prevention portion 106 can be attached with the side 104 and bottom portion 102 using any suitable means which allow for removal and reattachment, including threads, fasteners, snaps, and latches; thereby allowing the backflow prevention portion 106 to be separated from the bottom portion 102 and the side 104 allowing the vomit to be removed from the container 110.

The rim 108 is formed in any way that is suitable to collect vomit as it is expelled from the user's mouth and ensures the vomit is channeled through the backflow prevention portion 106 into the container 110. Similar to the bottom portion 102 and side 104, the rim 108 may be formed of any suitable, corrosion resistant, non-porous material. Non-limiting examples include, plastic, metal, composite, and ceramic.

Turning to FIG. 1B, the backflow prevention portion 106 in the present example includes a set of hinged doors 112. The hinged doors 112 operate by means of an elastic (flexible) portion 114 that allow the doors 112 to swing out of the way as the vomit passes through the rim 108 into the container 110. Once the vomit has passed through the backflow prevention portion 106, the elastic portion 114 causes the doors 112, to close (as depicted in FIG. 1A, element 112), effectively forming a check valve trapping the vomit within the container 110. The hinged doors 112 may be constructed of any suitable, corrosion resistant, non-porous material. Non-limiting examples include, plastic, metal, composite, and ceramic. The elastic portion 114 may be constructed out of any suitable, corrosion resistant material capable of storing mechanical energy. Non-limiting examples include, metal and elastomers. By utilizing the hinged doors 112 in the backflow prevention 106, we further increase the ability of the apparatus 100 to contain vomit once it has been expelled.

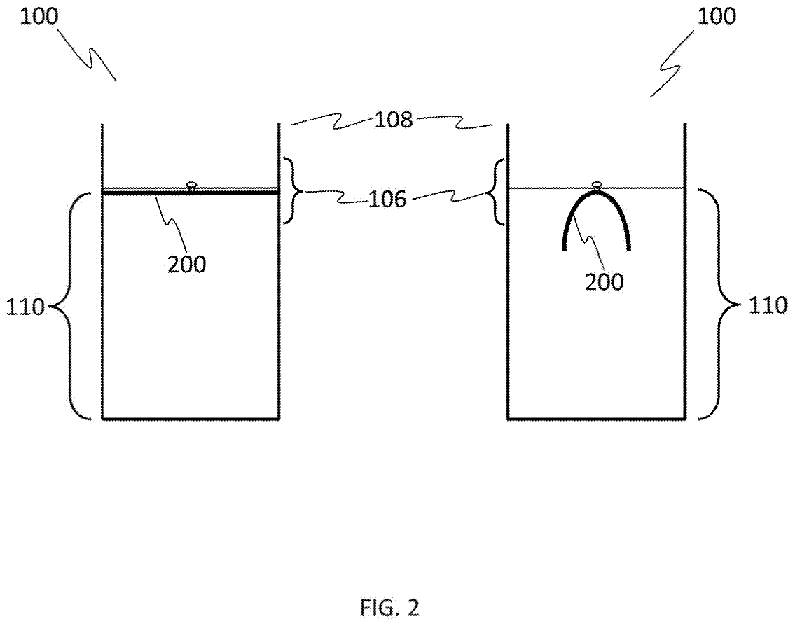

FIG. 2 displays another example of the apparatus 100, more specifically, it shows another version of the backflow prevention portion 106. In this aspect the backflow prevention portion 106 comprises an elastomer door 200. When the elastomer door 200 is resting it prevents vomit from escaping the container 110, but as vomit passes through the rim 108, it forces open the elastomer door 200. Once the vomit passes through the elastomer door 200 into the container 110, the elastomer door 200 closes again. Functionally, the elastomer door 200, is another form of check valve that opens when vomit passes through the rim 108 into the container 110, and closes once it has passed. The elastomer door 200 may be constructed out of any suitable, corrosion resistant material capable of storing mechanical energy. Non-limiting examples include, metal, and elastomers.

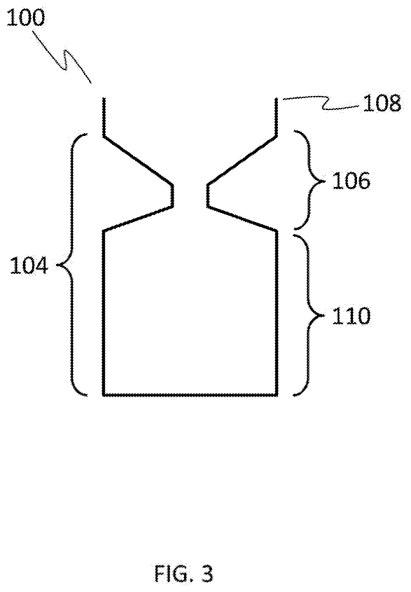

Another depiction of the backflow prevention portion 106 of the apparatus 100 is found in FIG. 3. In this aspect, the backflow prevention portion 106 is incorporated into the walls 104. The walls 104 are formed in a manner that allows vomit to enter through the rim 108, but restricts the movement of vomit upon entering the container 110, thereby reducing spillage. By incorporating the backflow prevention portion 106 into the wall 104, the complexity of the backflow prevention portion 106 is reduced and presumably, costs of the apparatus 100 generally.

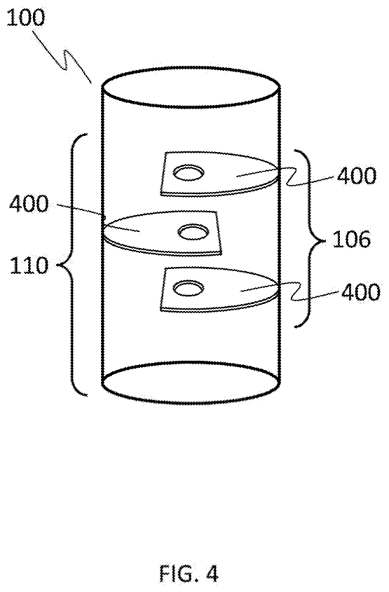

In FIG. 4 the perspective view of the apparatus depicts another version of the backflow prevention portion 106. In this aspect, the backflow prevention portion 106, comprises several baffles 400 which restrict movement of the vomit when it is within the container 110. The baffles 400 may be constructed out of any suitable, corrosion resistant, non-porous material, non-limiting examples include, plastic, metal, composite, and ceramic.

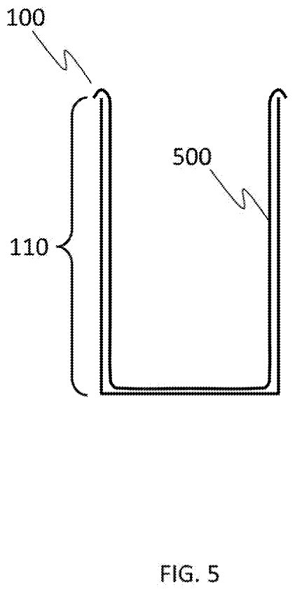

FIG. 5. is a depiction of the apparatus 100, with the addition of a removable disposable liner 500. Once vomit enters the container 110, the user may remove the removable disposable liner 500 and dispose of any vomit by disposing the removable disposable liner 500. The removable disposable liner 500 may be constructed out of any suitable, corrosion resistant, flexible, non-porous material, non-limiting examples include, plastic, and rubber. Clean up will be a major consideration for most users and by making a portion disposable as with the removable disposable liner 500, the user can expedite clean up and reduce the need to contact vomit during the clean-up process thereby increasing safety.

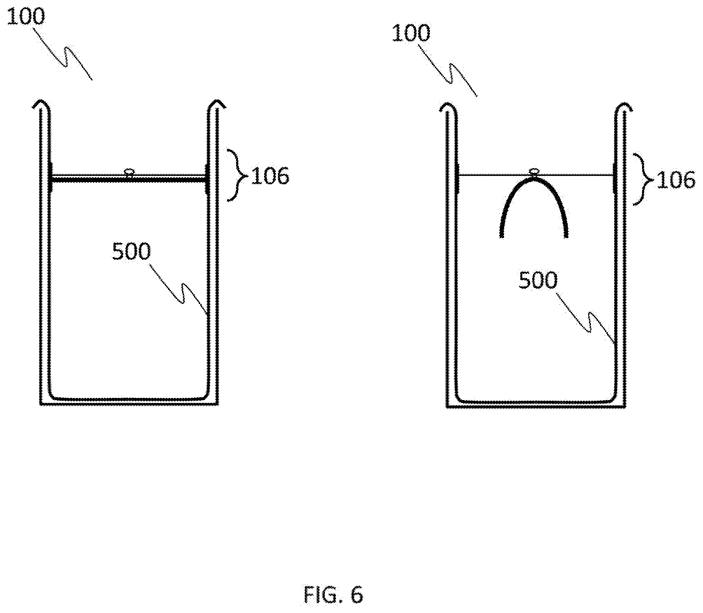

FIG. 6 displays another version of the disposable removable liner 500 concept. In this aspect, the backflow prevention portion 106 is incorporated in the disposable removable liner 500. This allows the backflow prevention portion 106 to be disposed of along with the disposable removable portion 500.

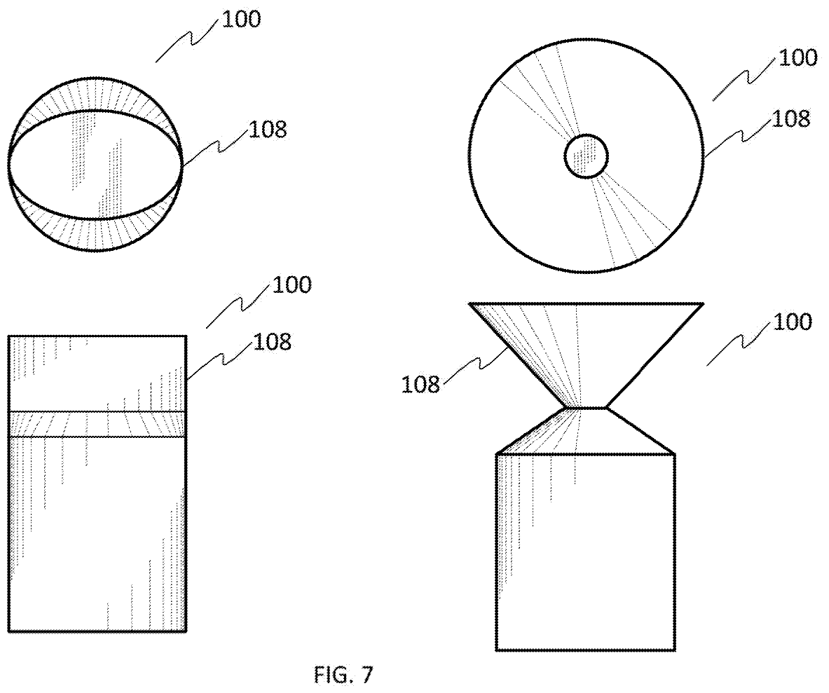

FIG. 7 depicts the apparatus 100 showing various configurations of the rim 108. The rim 108 can be shaped in any manner that allows it to conform to a user's mouth. By shaping the rim 108 in such a fashion, spillage during emesis is reduced.

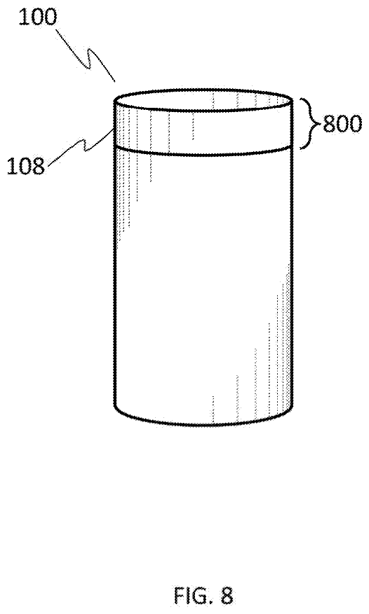

Another example of the apparatus 100 is shown in FIG. 8, this time showing another version of the rim 108. In this aspect of the rim 108, the rim 108 is made of a deformable material 800. The incorporation of deformable material 800 allows a user to place their mouth on the apparatus 100 and deform the deformable material 800. This increases comfort and decreases spillage during emesis. The deformable material 800 may be made of any suitable deformable, corrosion resistant material, non-limiting examples of which include, plastic, foam, and rubber.

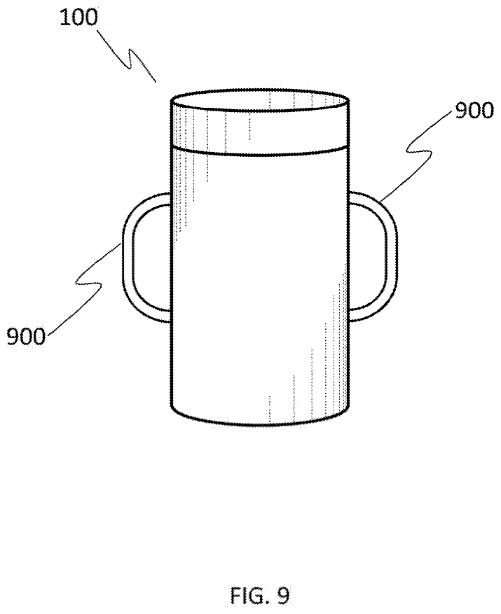

FIG. 9 shows a perspective view of the apparatus 100, this time depicting the incorporation of handles 900. Handles 900 allows the user to better grip the apparatus 100, thereby increasing comfort and improving operation of the apparatus 100. The handles 900 may be made of any suitable non-porous, corrosion resistant material, non-limiting examples of which include, plastic, foam, metal, and rubber.

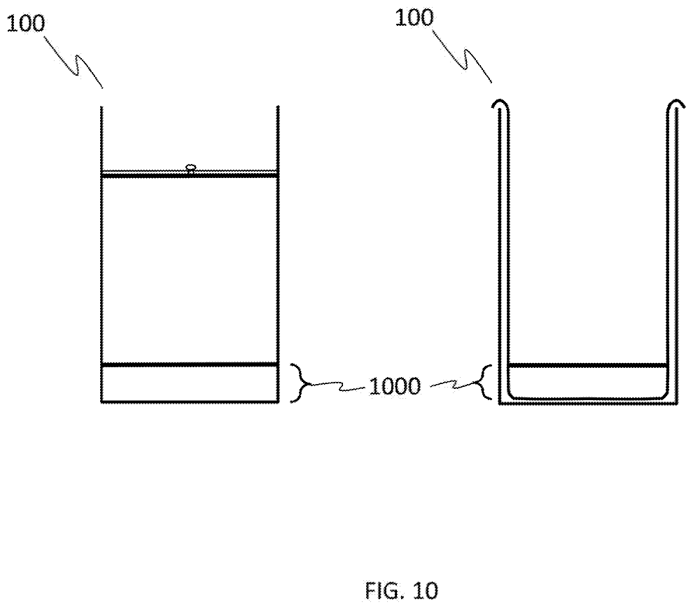

FIG. 10 displays another depiction of the apparatus 100, illustrating the incorporation of an absorbent material 1000. By incorporating an absorbent material 1000 the apparatus 100 will slowly convert liquid vomit into solids. This will increase safety by decreasing the risk of spillage. The absorbent material 1000 may be made of any suitable absorbent, corrosion resistant material, non-limiting examples of which include, sponges, and sodium polyacrylate.

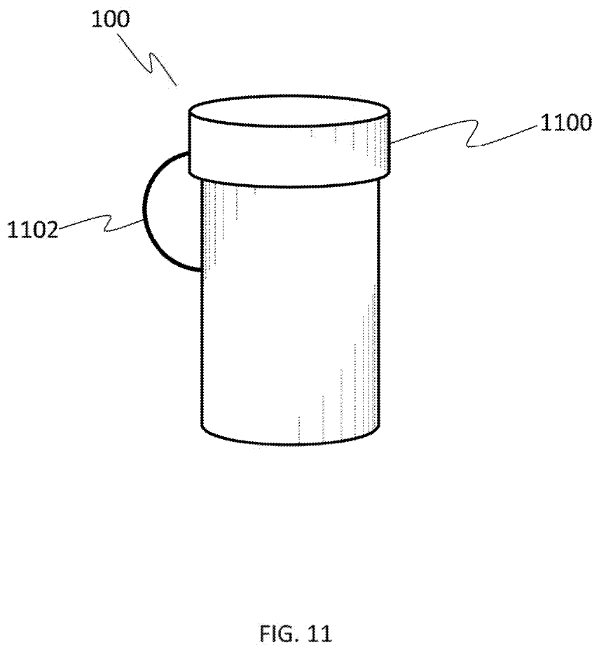

Another depiction of the apparatus 100 is shown in FIG. 11, which depicts the incorporation of a cap 1100 and leash 1102. The cap 1100 is formed in a manner that allows it to either snap or screw on to the rim 108 and is constructed of any suitable material, non-limiting examples of which include, plastic, metal, ceramic, rubber, and composite. One end of the leash 1102 is attached to the cap 1100 and the other end is attached to some portion of the apparatus 100, either the rim 108, the container 110 or the backflow prevention portion 106. The incorporation of a cap 1100 and leash 1102 increases portability and user comfort because the portions of the apparatus 100 that are unsightly or contaminated can be covered up by the cap 1100 and the user can better transport the apparatus 100. Additionally, the cap 1100 would serve to help reduce odors.

A further aspect not depicted by any figure is the incorporation of antimicrobial materials into all components of the apparatus. Since the apparatus will interact with and contain bodily fluids and as a normal part of operation will be held by the user incorporating materials with antimicrobial properties will increase user safety.

In another aspect which is not depicted by any figure, the apparatus may incorporate a chemical deodorant either into the absorbent material or into another component of the apparatus. Any suitable chemical deodorant may be used, non-limiting examples of which include, polyethylene glycol octylphenyl ether, dipropylene glycol, and dipropylene glycol monomethyl ether.

What is claimed is:

1. An apparatus for containing vomit comprising:
a bottom portion;
a side proximate the bottom portion;
a backflow prevention portion proximate the side;
and a rim proximate the backflow prevention portion and opposite the bottom portion, such that the bottom portion, side and backflow prevention portion form a container capable of holding vomit.

2. An apparatus as set forth in claim 1, wherein the backflow prevention portion comprises:
at least one hinged door arranged in a fashion that when closed, the door substantially confines the vomit within the container;
an elastic portion affixed to the door and the walls, such that the door will remain closed unless vomit introduced via the rim forces the door open and following passage of the vomit will cause the door to close.

3. An apparatus as set forth in claim 1, wherein the backflow prevention portion comprises at least one elastomer door arranged in a fashion that when closed substantially confine the vomit within the container, wherein the elastomer door will remain closed unless vomit introduced via the rim forces the elastomer door open and following passage of the vomit will return to the closed position.

4. An apparatus as set forth in claim 1, wherein the backflow prevention portion is incorporated into the walls and the walls are formed in such a manner that restricts the movement of vomit within the container.

5. An apparatus as set forth in claim 1, wherein the backflow prevention portion comprises at least one baffle which restricts the movement of vomit within the container.

6. An apparatus as set forth in claim 1, wherein the apparatus further comprises a removable disposable liner which substantially conforms to the interior of the container.

7. An apparatus as set forth in claim 6, wherein the backflow prevention portion is incorporated into the removable disposable liner.

8. An apparatus as set forth in claim 1, wherein the rim is shaped in a manner that allows it to conform to a user's mouth.

9. An apparatus as set forth in claim 8, wherein the rim is made of a deformable material to increase conformance with the user's mouth.

10. An apparatus as set forth in claim 1, wherein the apparatus further incorporates at least one handle proximate the container.

11. An apparatus as set forth in claim 1, wherein the apparatus further incorporates antimicrobial materials.

12. An apparatus as set forth in claim 1, wherein the apparatus further incorporates an absorbent material.

13. An apparatus as set forth in claim 1, wherein the apparatus further incorporates a chemical deodorant.

14. An apparatus as set forth in claim 1, wherein the apparatus further incorporates a removable cap proximate the rim.

15. An apparatus as set forth in claim 14, wherein the apparatus further incorporates a leash which is proximate to the container and proximate to the removable cap.

16. A method for forming an apparatus for containing vomit comprising:
forming a bottom portion, a side, a backflow prevention portion and a rim affixing the side to the bottom portion;
affixing the backflow prevention portion to the side opposite the bottom portion such that the bottom portion, side and backflow prevention portion form a container capable of holding vomit; and
affixing the rim to the backflow prevention portion opposite side.

17. A method for forming an apparatus for containing vomit comprising:
forming a bottom portion, a side, a backflow prevention portion, a disposable removable liner and a rim;
affixing the side to the bottom portion;
affixing the rim to the side opposite the bottom portion, such that the bottom portion, side and rim form a container;
affixing the backflow prevention portion to the disposable removable liner; and
inserting the disposable removable liner into the container such that the backflow prevention portion of the disposable removable liner is proximate to the rim.

18. An apparatus as set forth in claim 1, wherein the backflow prevention portion and rim is separable from the side such that when the backflow prevention portion is separated from the side the vomit may be removed from the container.
